(19) United States
(12) Patent Application Publication
(10) Pub. No.: US 2007/0128489 A1
(43) Pub. Date: Jun. 7, 2007

(54) Film electrode junction for fuel cell and fuel cell

(76) Inventors: Toru Koyama, Hitachi (JP); Hidetoshi Honbou, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/527,425

(22) Filed: Sep. 27, 2006

(30) Foreign Application Priority Data
Dec. 2, 2005 (JP) 2005-349099

(51) Int. Cl. H01M 8/10; H01M 4/96

(52) U.S. Cl. 429/30; 429/44; 429/42

(57) ABSTRACT

The object of the invention is to improve the output performance of a fuel cell. The object is attained by a film electrode junction, characterized in that it comprises a polymer electrolyte film and a cathode electrode and an anode electrode between which the polymer electrolyte film is interposed, the cathode electrode and anode electrode respectively contain a carbon powder, an electrode catalyst supported on the carbon powder and a polymer electrolyte binder, at least one of the polymer electrolyte of the cathode electrode on the fuel feeding side and the cathode side of the polymer electrolyte film is an electrolyte containing fluorine, and the polymer electrolyte of the anode electrode is a hydrocarbon electrolyte.

### FIELD OF THE INVENTION

The present invention relates to a film electrode junction, a fuel cell and fuel cell electric source system using the same, and an electronic equipment having the fuel cell electric source system mounted thereon.

### BACKGROUND OF THE INVENTION

Polymer fuel cells using hydrogen as a fuel, and polymer fuel cells using a liquid such as methanol, dimethyl ether or ethylene glycol as a fuel have the features that they are high in output density, low-temperature operability and environmental harmonization. Therefore, development of the fuel cells is promoted for practical use of electric sources for automobiles, electric forces for dispersion type cogeneration and electric sources for mobiles.

When a hydrocarbon electrolyte film is used as a polymer electrolyte film, fluorine-containing electrolytes are generally used as polymer electrolyte binders which adhere the polymer electrolyte film and a catalyst-supporting carbon powder or the catalyst-supporting carbon powders per se and which conduct protons for both the anode electrode and the cathode electrode (Patent Document 1).

Patent Document 1: JP-A-2002-110174

### BRIEF SUMMARY OF THE INVENTION

Polymer fuel cells generate electricity and heat simultaneously by electrochemical reaction of a fuel such as hydrogen or methanol and an oxidant gas containing oxygen, such as air. The film electrode junction which is most important for electricity generation can be mentioned as greatly governing the cost, efficiency and endurance of polymer fuel cells which are operated using hydrogen or methanol as a fuel. The structure of the film electrode junction is shown in FIG. 1. The film electrode junction comprises a polymer electrolyte film 1, an anode electrode 2 which comprises a carbon powder supporting a catalyst such as an platinum-ruthenium alloy and a polymer electrolyte and which is provided on one side of the polymer electrolyte film 1, and a cathode electrode 3 which comprises a carbon powder supporting a catalyst such as platinum and a polymer electrolyte and which is provided on another side of the polymer electrolyte film 1. Furthermore, an anode diffusion layer 4 having both the permeability to the fuel and the ionic conductivity is provided on the outside of the anode electrode 2, and a cathode diffusion layer 5 having both the permeability to an oxidizing gas and the electronic conductivity is provided on the outside of the cathode electrode 3.

As the polymer electrolyte film 1, there are used fluorine-containing electrolyte films such as polyperfluorosulfonic acid and hydrocarbon electrolyte films such as engineering plastics having sulfonic acid groups or alkylenesulfonic acid groups. The hydrocarbon electrolyte films are advantageous as the polymer electrolyte film since they hardly cause crossover of fuel.

When a fuel cell is fabricated using a film electrode junction in which a hydrocarbon electrolyte film is used as the polymer electrolyte film 1, and a fluorine-containing electrolyte is used for both the anode electrode 2 and the cathode electrode 3 as a polymer electrolyte which adheres the polymer electrolyte film 1 and catalyst-supporting carbon powders or catalyst-supporting carbon powders per se and which conducts protons, and when this fuel cell is operated, there is the problem that the output of the fuel cell reduces in a short time.

Similarly, there is the problem that when a fuel cell is fabricated using a film electrode junction in which a hydrocarbon electrolyte film is used as the polymer electrolyte film 1, and a hydrocarbon electrolyte is used for both the anode electrode 2 and the cathode electrode 3 as a polymer electrolyte which adheres the polymer electrolyte film 1 and catalyst-supporting carbon powders or catalyst-supporting carbon powders per se and which conducts protons, and when this fuel cell is operated, there is the problem that the output of the fuel cell reduces in a short time.

The object of the present invention is to inhibit deterioration of the film electrode junction which uses a polymer electrolyte, thereby to inhibit reduction of the output of the fuel cell over a long period of time.

The present invention provides a film electrode junction comprising:

a polymer electrolyte film; and

a cathode electrode and an anode electrode between which the polymer electrolyte film is interposed;

wherein the cathode electrode and the anode electrode respectively contain a carbon powder, an electrode catalyst supported on the carbon powder and a polymer electrolyte binder;

at least one of the polymer electrolyte binder of the cathode electrode and a cathode side electrolyte film contain a fluorine-containing electrolyte; and

at least one of the polymer electrolyte binder of the anode electrode and an anode side electrolyte film contain a hydrocarbon electrolyte, and the present invention further provides a fuel cell using the film electrode junction, and an electronic equipment using the fuel cell.

Other objects, features and advantages of the invention will become apparent from the following description of the embodiments of the invention taken in conjunction with the accompanying drawings.

### BRIEF DESCRIPTION OF THE DRAWINGS

FIG. 1 schematically shows the construction of the film electrode junction according to the Example of the present invention.

FIG. 2 shows a monocell of the polymer fuel cell electricity generation apparatus according to the Example of the present invention.

FIG. 3 is a graph which shows current-voltage characteristics according to the Example of the present invention.

FIG. 4 is a graph which shows change with time of the output voltage according to the Example of the present invention.

FIG. 5 is a graph which shows current-voltage characteristics according to the Comparative Example.

FIG. 6 is a graph which shows change with time of the output voltage according to the Comparative Example.

FIG. 7 is a graph which shows current-voltage characteristics according to the other Comparative Example.

FIG. 8 is a graph which shows change with time of the output voltage according to the other Comparative Example.

FIG. 9 is a developed oblique view of the monocell of the polymer fuel cell electricity generation apparatus according to the Example of the present invention.

FIG. 10 is a developed oblique view of the fuel cell according to the Example of the present invention.

FIG. 11 is a diagram which shows a fuel cell electric source system having the fuel cell using the film electrode junction of the present invention.

FIG. 12 is a sectional view showing a portable information terminal having a fuel cell electric source system using the fuel cell comprising the film electrode junction of the present invention.

FIG. 13 is an electron micrograph showing a polymer electrolyte composite film according to the Example of the present invention.

FIG. 14 is an electron micrograph showing a polymer electrolyte composite film according to another Example of the present invention.

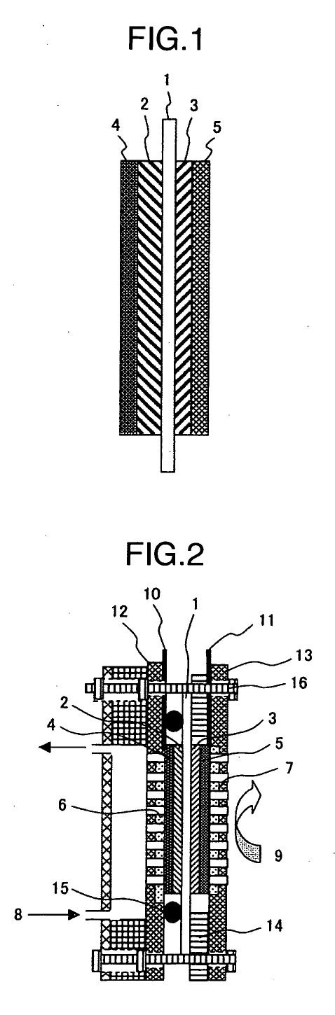

### DESCRIPTION OF REFERENCE NUMERALS

1 - - - polymer electrolyte, 2 - - - anode electrode, 3 - - - cathode electrode, 4 - - - anode diffusion layer, 5 - - - cathode diffusion layer, 6 - - - anode current collector, 7 - - - cathode current collector, 8 - - - fuel, 9 - - - air, 10 - - - anode terminal, 11 - - - cathode terminal, 12 - - - anode terminal plate, 13 - - - cathode terminal plate, 14 gasket, 15 - - - O-ring, 16 - - - bolt/nut, 17 - - - fuel guide passage of separator, 18 - - - air guide passage, 19 - - - hydrogen+water, 20 - - - hydrogen, 21 - - - water, 22 - - - air, 23 - - - air+water, 101 - - - fuel cell, 102 - - - fuel cartridge, 103 - - - cathode terminal plate, 104 - - - cathode current collector, 105 - - - the part in which MEA with diffusion layers is provided, 106 - - - packing, 107 - - - anode terminal plate, 108 - - - fuel tank part, 109 - - - anode terminal plate, 110 - - - electric double layer condenser, 111 - - - DC/DC converter, 112 - - - discriminative controlling means, 113 - - - load cutting-off switch, 122c - - - slit, 201 - - - display device, 202 - - - main board, 203 - - - antenna, 204 - - - hinge with cartridge holder, 205 - - - main board, 206 - - - partition wall, 207 - - - air filter, 208 - - - water absorbing quick-drying material, 210 - - - case

### DETAILED DESCRIPTION OF THE INVENTION

The particularly important embodiments of the present invention are as follows. One of them is a film electrode junction, characterized in that it comprises a polymer electrolyte film and a cathode electrode and an anode electrode between which the polymer electrolyte film is interposed, the cathode electrode and anode electrode contain at least a carbon powder, an electrode catalyst supported on the carbon powder and a polymer electrolyte binder, and the polymer electrolyte binder of the cathode electrode is a fluorine-containing electrolyte and the polymer electrolyte of the anode electrode is a hydrocarbon electrolyte, and another one of the important embodiments is a film electrode junction, characterized in that it comprises a polymer electrolyte film and a cathode electrode and an anode electrode between which the polymer electrolyte film is interposed, the cathode electrode and anode electrode contain at least a carbon powder, an electrode catalyst supported on the carbon powder and a polymer electrolyte binder, and the cathode electrode side of the electrolyte film is a fluorine-containing electrolyte film and the anode electrode side of the polymer electrolyte film is a hydrocarbon electrolyte film.

The inventors have conducted detailed researches on the reasons for the reduction of output of fuel cell, and as a result, accomplished the present invention.

When a film electrode junction is made by using a fluorine-containing electrolyte film as the polymer electrolyte film 1, and using a fluorine-containing electrolyte for both the anode electrode 2 and the cathode electrode 3 as a polymer electrolyte which adheres catalyst-supporting carbon powders to the polymer electrolyte film 1 or adheres the catalyst-supporting carbon powders per se to each other, and which conducts protons, and when the resulting film electrode junction is incorporated in a fuel cell, and electricity is generated for a long time using hydrogen as a fuel, the following factors are considered as the main reasons for reduction of output of electricity generation.

1. Oxygen crossleaks through the electrolyte film and reaches the anode electrode (catalyst) to cause direct burning here. Hydrogen peroxide produced there as a by-product produces hydroxyl radicals by the action of a hydrogen peroxide decomposing catalyst such as Fe²⁺ ion present in the film, and the hydroxyl radicals attack the electrolyte film on the anode side to cause decomposition.

2. Oxygen is converted to hydrogen peroxide on the cathode electrode (catalyst), and this hydrogen peroxide diffuses into the electrolyte film and produces hydroxyl radicals by the action of a hydrogen peroxide decomposing catalyst such as Fe²⁺ ion present in the film. The hydroxyl radicals attack the electrolyte film on the cathode side to cause decomposition.

3. Catalyst particles grow due to dissolution, precipitation and agglomeration of the cathode catalyst to result in reduction of reaction area of the cathode catalyst.

4. Dissolution of Ru or the like in the anode catalyst occurs, resulting in variation of alloy composition and growth of catalyst particles to cause reduction of reaction area of the anode catalyst.

5. Water repellency of the cathode diffusion layer deteriorates.

On the other hand, a film electrode junction is made in which a hydrocarbon electrolyte film is used as the polymer electrolyte film 1, and a fluorine-containing electrolyte is used for both the anode electrode 2 and the cathode electrode 3 as a polymer electrolyte binder which adheres the polymer electrolyte film 1 and the catalyst-supporting carbon powders or adheres the catalyst-supporting carbon powders per se to each other and which conducts protons. When the thus obtained film electrode junction is incorporated in a fuel cell, and this fuel cell is operated, the reduction in output of this fuel cell is examined in detail to find that separation occurs between the polymer electrolyte film 1 and the anode electrode 2 and between the polymer electrolyte film 1 and the cathode electrode 3 to cause increase of resistance, which is a main reason for the reduction of output.

Furthermore, a film electrode junction is made in which a hydrocarbon electrolyte film is used as the polymer electrolyte film 1, and a hydrocarbon electrolyte is used for both the anode electrode 2 and the cathode electrode 3 as a polymer electrolyte binder which adheres the polymer electrolyte film 1 and the catalyst-supporting carbon powders or adheres the catalyst-supporting carbon powders per se to each other and which conducts protons. When the thus obtained film electrode junction is incorporated in a fuel cell, and this fuel cell is operated, the reduction in output of the fuel cell is examined in detail to find that the hydrocarbon electrolyte in the cathode electrode 2 is deteriorated to result in change of the structure of the cathode electrode, which is a main reason for the reduction of output.

Upon further continuation of examination, it has been found that in the case of using a hydrocarbon electrolyte film as the polymer electrolyte film 1, when a hydrocarbon polymer is used as the polymer electrolyte which adheres the polymer electrolyte film 1 and the anode catalyst-supporting carbon powders or adheres the anode catalyst-supporting carbon powders per se to each other and which conducts protons, the polymer electrolyte is of the same material as of the polymer electrolyte film 1 to strengthen the adhesion, and hence the separation between the polymer electrolyte film 1 and the anode electrode can be avoided. Furthermore, it has been found that when a fluorine-containing electrolyte is used as the polymer electrolyte binder which adheres the polymer electrolyte film 1 and the cathode catalyst-supporting carbon powders or adheres the cathode catalyst-supporting carbon powders per se to each other and which conducts protons, the electrolyte in the cathode electrode is not deteriorated and electrode structure is stable.

That is, it has been found that in the case of using a hydrocarbon electrolyte film as the polymer electrolyte film 1, the above problems can be solved by using a hydrocarbon electrolyte as the polymer electrolyte binder of the anode electrode and a fluorine-containing electrolyte as the polymer electrolyte binder of the cathode electrode.

Further, it has been found that a polymer electrolyte composite film comprising a hydrocarbon electrolyte film on the anode side and a fluorine-containing electrolyte film on the cathode side as the polymer electrolyte film of the film electrode junction is superior in endurance to a polymer electrolyte composite film comprising a fluorine-containing electrolyte film on the anode side and a hydrocarbon electrolyte film on the cathode side, and a fuel cell using the former polymer electrolyte composite film can more stably generate the electricity.

Moreover, it has been found that generation of the electricity can be further stably performed by using a polymer electrolyte composite film comprising a hydrocarbon electrolyte film on the anode side and a fluorine-containing electrolyte film on the cathode side as the polymer electrolyte film of the film electrode junction, and by using a hydrocarbon electrolyte as the polymer electrolyte binder of the anode electrode and a fluorine-containing electrolyte as the polymer electrolyte binder of the cathode electrode.

The embodiments of the present invention will be explained in detail below.

The polymer electrolyte films used in the present invention are not particularly limited as long as they are hydrocarbon electrolyte films. As these electrolyte films, mention may be made of, for example, sulfonated engineering plastic electrolyte films such as those of sulfonated polyether ether ketone, sulfonated polyether sulfone, sulfonated acrylonitrile-butadiene-styrene polymer, sulfonated polysulfide and sulfonated polyphenylene, sulfoalkylated engineering plastic electrolyte films such as those of sulfoalkylated polyether ether ketone, sulfoalkylated polyether sulfone, sulfoalkylated polyether ether sulfone, sulfoalkylated polysulfone, sulfoalkylated polysulfide, sulfoalkylated polyphenylene and sulfoalkylated polyether ether sulfone, hydrocarbon electrolyte films such as those of sulfoalkyletherified polyphenylene, and the like.

Among them, sulfoalkylated hydrocarbon electrolyte films and sulfoalkyletherified hydrocarbon electrolyte films are preferred from the viewpoints of crossover of fuel, ionic conductivity, swelling properties, etc. Fuel cells capable of being operated in the higher temperature area can be made by using a composite electrolyte film obtained by micro-dispersing in a heat resistant resin a hydrogen ion conducting inorganic material such as hydrated tungsten oxide, hydrated zirconium oxide, hydrated tin oxide, silico-tungstic acid, silico-molybdic acid, tungsto-phosphoric acid or molybdic acid.

The above-mentioned hydration type acidic electrolyte films often deform due to swelling in drying state and wetting state, which may result in insufficient mechanical strength for films having sufficiently high ionic conductivity. In this case, it is effective for enhancing reliability of cell performance to use as a core material a fiber in the form of nonwoven or woven fabric excellent in mechanical strength, endurance and heat resistance, to add the above fiber as a filler in preparation of the electrolyte film to reinforce the film, or to use a polymer film having pores piercing therethrough as a core material.

Furthermore, in order to reduce fuel permeability of the electrolyte film, there may also be used a film comprising polybenzimidazole doped with sulfuric acid, phosphoric acid, sulfonic acid or phosphonic acid. Moreover, in preparation of the polymer electrolyte film used in the present invention, there may be used additives such as plasticizers, antioxidants, hydrogen peroxide decomposing agents, metal scavengers, surface active agents, stabilizers, and releasing agents which are used for general polymers, so long as attainment of the object of the present invention is not hindered.

The sulfonic acid equivalent of the polymer electrolyte film is preferably from 0.5 to 2.0 milli-equivalent/g dry resin, more preferably from 0.8 to 1.5 milli-equivalent/g dry resin. If the sulfonic acid equivalent is smaller than the above range, ionic conduction resistance increases, and if it is larger than the above range, the film is readily dissolved in an aqueous solution of fuel such as aqueous methanol solution, which is not preferred. The thickness of the polymer electrolyte film is not particularly limited, and is preferably from 10 to 300 μm, especially preferably from 15 to 200 μm. For obtaining practically acceptable strength of the film, a thickness of more than 10 μm is preferred, and for reduction of film resistance, namely, improvement of electricity generation performance, a thickness of less than 200 μm is preferred. In the case of employing solvent casting method, the thickness can be controlled by the solution concentration or the coating thickness on a substrate. In the case of forming the film from molten state, the thickness can be controlled by stretching a film of a given thickness obtained by melt pressing method or melt extrusion method at a given stretching ratio.

The hydrocarbon polymer electrolyte binder which adheres the polymer electrolyte film and the anode catalyst-supporting carbon powders or adheres the anode catalyst-supporting carbon powders per se and which conducts protons is not particularly limited as long as it is a hydrocarbon electrolyte. Examples of such polymer electrolyte are sulfonated engineering plastics electrolytes such as sulfonated polyether ether ketone, sulfonated polyether sulfone, sulfonated acrylonitrile-butadiene-styrene polymer, sulfonated polysulfide and sulfonated polyphenylene, sulfoalkylated engineering plastics electrolytes such as sulfoalkylated polyether ether ketone, sulfoalkylated polyether sulfone, sulfoalkylated polyether ether sulfone, sulfoalkylated polysulfone, sulfoalkylated polysulfide, sulfoalkylated polyphenylene and sulfoalkylated polyether ether sulfone, hydrocarbon electrolytes such as sulfoalkyletherified polyphenylene, and the like.

Among them, preferred are polymer electrolytes having good oxidation resistance. The sulfonic acid equivalent of the polymer electrolytes is preferably from 0.5 to 2.5 milli-equivalent/g dry resin, more preferably from 0.8 to 1.8 milli-equivalent/g dry resin. The sulfonic acid equivalent of the polymer electrolytes is preferably greater than the equivalent of the polymer electrolyte films from the viewpoint of ionic conductivity. There may be used additives which are used for general polymers, such as plasticizers, antioxidants, hydrogen peroxide decomposing agents, metal scavengers, surface active agents, stabilizers, and releasing agents so long as attainment of the object of the present invention is not hindered.

The fluorine-containing polymer electrolyte binder which adheres the polymer electrolyte film 1 and the cathode catalyst-supporting carbon powders or adheres the cathode catalyst-supporting carbon powders per se and which conducts protons is not particularly limited as long as it is a fluorine-containing electrolyte. Polyperfluorosulfonic acid and the like are used as the fluorine-containing electrolytes. The typical examples thereof are Nafion (trade mark: manufactured by DuPont Co. of U.S.A.), Aciplex (trade mark: manufactured by Asahi Chemical Industry Co., Ltd.), and Flemion (trade mark: manufactured by Asahi Glass Co., Ltd.). The sulfonic acid equivalent of these electrolytes is preferably greater than the equivalent of the polymer electrolyte films from the viewpoint of ionic conductivity.

The anode catalysts or cathode catalysts may be any metals which accelerate oxidation reaction of fuel and reduction reaction of oxygen, and as examples thereof, mention may be made of platinum, gold, silver, palladium, iridium, rhodium, ruthenium, iron, cobalt, nickel, chromium, tungsten, manganese, vanadium, titanium, and alloys thereof. Of these catalysts, particularly, platinum is used in many cases. The particle diameter of the metals as catalysts is usually from 2 to 30 nm. It is advantageous from the point of cost to support the catalyst on a carrier such as carbon because the amount of the catalyst used is smaller. The amount of the catalyst supported is preferably from 0.01 to 20 mg/cm² in the state of the electrode being shaped.

The electrode used in the film electrode junction is composed of a conductive material supporting fine particles of the catalyst metal thereon, and, if necessary, may contain a water repellant or a binder. Furthermore, a layer comprising a conductive material supporting no catalyst and the water repellant or binder contained as required may be formed outside a catalyst layer. The conductive materials on which the catalyst metal is supported may be any materials as long as they are electron conductive materials, and examples thereof are various metals and carbon materials. As the carbon materials, there may be used, for example, carbon blacks such as furnace black, channel black and acetylene black, fibrous carbon such as carbon nanotubes, active carbon, graphite, etc. These may be used each alone or in admixture.

As the water repellant, for example, fluorinated carbon is used. The binder used is preferably a solution of the same kind of hydrocarbon electrolyte as of the electrolyte film from the viewpoint of adhesion, but other various resins may also be used. Furthermore, there may be added fluorine-containing resins having water repellency, such as polytetrafluoroethylene, tetrafluoroethylene-perfluoroalkylvinyl ether copolymer and tetrafluoroethylene-hexafluoropropylene copolymer.

The method for bonding the polymer electrolyte film and the electrodes in making a fuel cell is not particularly limited, and known methods can be used. An example of the method for making the film electrode junction is as follows. A Pt catalyst powder supported on a conductive material, for example, carbon, is mixed with a polytetrafluoroethylene suspension, and the mixture is coated on a carbon paper and heat treated to form a catalyst layer.

Then, a solution of the same polymer electrolyte as the polymer electrolyte film or a fluorine-containing electrolyte as a binder is coated on the catalyst layer, and the coated catalyst layer is integrated with the polymer electrolyte film by a hot press. In addition, there are a method of previously coating a solution of the same polymer electrolyte as of the polymer electrolyte film on a Pt catalyst powder, a method of coating a catalyst paste on the polymer electrolyte film by printing method, spray method or ink jet method, a method of electroless plating of electrode on the polymer electrolyte film, a method of adsorbing a platinum group metal complex ion to the polymer electrolyte film and then reducing it, and other methods. Of these methods, the method of coating the catalyst paste on the polymer electrolyte film by ink jet method is smaller in loss of the catalyst and hence this method is superior.

The direct methanol fuel cell (DMFC) is constructed as follows. A monocell is formed by disposing outside the film electrode junction produced as mentioned above a fuel feeding plate and an oxidizing agent feeding plate as current collectors having grooves which form a fuel flow path and an oxidizing agent flow path. A plurality of these monocells are laminated with interposing cooling plates or the like therebetween, thereby forming the DMFC. For connection of the monocells, there is a method of connecting them in planar state in addition to the lamination method. The monocells may be connected by any of these methods.

It is preferred to operate a fuel cell at higher temperatures because catalytic activity of electrode increases and over-voltage of electrode decreases, but the operating temperature is not particularly limited. It is also possible to gasify a liquid fuel and operate the fuel cell at high temperatures.

A plurality of monocells comprising an anode, an electrolyte film and a cathode are prepared and are disposed in plane, and the respective monocells are connected in series by a conductive inter-connector, whereby high voltage can be obtained, and the fuel cell can be operated without using a subsidiary device for forced feeding of fuel or oxidizing agent and a subsidiary device for forced cooling of the fuel cell. A small electric source which can continue generation of electricity for a long time can be realized by using an aqueous methanol solution of high volume energy density as a liquid fuel. This small electric source can be incorporated, for example, in portable telephones, book-type personal computers and portable video cameras to operate them, and they can be used continuously for a long time by supplying the previously prepared fuel as needed.

Furthermore, for the purpose of sharply reducing the number of times of the fuel supply, it is effective to use the small electric source as a battery charger by connecting the small electric source with, for example, a charger of portable telephones, book-type personal computers and portable video cameras having a secondary battery and to fit it with a part of the storing case of them. In this case, at the time of using the portable electronic device, it is taken out of the case and operated by the secondary battery, and at the time of not using it, it is stored in the case, whereby the electricity generation device of the small fuel cell contained in the case is connected with the portable electronic device through the charger to charge the secondary battery. Thus, volume of the fuel tank can be made larger, and the number of times of fuel supply can be sharply reduced.

### EXAMPLES

The present invention will be explained in more detail by the following Examples, which should not be construed as limiting the invention in any manner.

### Example 1

(1) Preparation of chloromethylated polyether sulfone:

The inside of a four-necked round flask of 500 ml equipped with a stirrer, a thermometer, and a reflux condenser having a calcium chloride tube was replaced with nitrogen, then 30 g of polyether sulfone (PES) and 250 ml of tetrachloroethane were charged in the flask, and, furthermore, 40 ml of chloromethylmethyl ether was added, and thereafter a mixed solution of 1 ml of anhydrous tin chloride (IV) and 20 ml of tetrachloroethane was dropped in the mixture, followed by heating at 80° C. and stirring for 90 minutes under heating.

Then, the reaction mixture was dropped in 1 liter of methanol to precipitate a polymer. The resulting precipitate was ground by a mixer and washed with methanol to obtain chloromethylated polyether sulfone. The chloromethyl group introduction rate {the proportion of structural units into which chloromethyl group was introduced to all structural units (total of x and y) in (formula 1)} according to nuclear magnetic resonance spectrum was 36%.

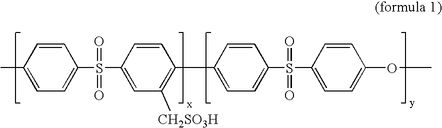

(2) Preparation of acetylthionated polyether sulfone:

The resulting chloromethylated polyether sulfone was charged in a four-necked round flask of 1000 ml equipped with a stirrer, a thermometer, and a reflux condenser having a calcium chloride tube, and 600 ml of N-methylpyrrolidone was added thereto, followed by adding 9 g of potassium thioacetate and 50 ml of a N-methylpyrrolidone (NMP) solution, and heating to 80° C. and stirring for 3 hours under heating. Then, the resulting reaction mixture was dropped in 1 liter of water to precipitate a polymer. The precipitate was ground by a mixer and washed with water, and then dried with heating to obtain 32 g of acetylthionated polyether sulfone.

(3) Preparation of sulfomethylated polyether sulfone:

Twenty grams of the resulting acetylthionated polyether sulfone was charged in a four-necked round flask of 500 ml equipped with a stirrer, a thermometer, and a reflux condenser having a calcium chloride tube, and 300 ml of acetic acid was further added thereto. Then, 20 ml of aqueous hydrogen peroxide was added, followed by heating to 45° C. and stirring for 4 hours under heating.

Then, the resulting reaction mixture was added to 1 liter of 6N aqueous sodium hydroxide solution under cooling, followed by stirring for a while. The resulting polymer was filtered off, and washed with water until the alkali component was removed. Thereafter, the polymer was added to 300 ml of 1N hydrochloric acid, followed by stirring for a while. The polymer was filtered off, washed with water until the acid component was removed, and vacuum dried to obtain quantitatively 20 g of sulfomethylated polyether sulfone. The presence of sulfomethyl group was confirmed by the fact that the chemical shift of methylene proton in NMR shifted to 3.78 ppm. The sulfomethyl group introduction rate {the proportion of structural units into which sulfomethyl group was introduced to all structural units (total of x and y) in (formula 2)} was 36% from the introduction rate of chloromethyl group.

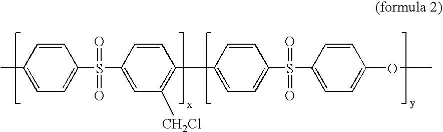

(4) Production of polymer electrolyte film:

The sulfomethylated polyether sulfone obtained in the above (3) was dissolved in a mixed solvent (1:1) of dimethylacetamide-methoxyethanol so as to give a concentration of 5% by weight. This solution was spread on a glass by spin coating, and air-dried and then vacuum dried at 80° C. to obtain a sulfomethylated polyether sulfone electrolyte film having a thickness of 42 μm. This polymer electrolyte film had a methanol permeability of 12 mA/cm² and an ionic conductivity of 0.053 S/cm at room temperature.

(5) Production of film electrode junction (MEA):

Sulfomethylated polyether sulfone having a sulfomethyl group introduction rate {the proportion of structural units into which sulfomethyl group was introduced to all structural units (total of x and y) in (formula 2)} of 41% was prepared in the same manner as in the above (1), (2) and (3), and this was used as the polymer electrolyte of the anode electrode.

A slurry comprising a catalyst powder prepared by dispersing and supporting, on a carbon carrier, 50% by weight of platinum/ruthenium alloy fine particles having an atomic ratio of platinum and ruthenium of 1/1 and 30% by weight of the above polymer electrolyte (sulfomethylated polyether sulfone) in a mixed solvent of 1-propanol, 2-propanol and methoxyethanol was prepared, and using this slurry an anode electrode of about 125 μm in thickness, 30 mm in width and 30 mm in length was formed on a polyimide film by screen printing method.

Then, a slurry comprising a catalyst powder prepared by supporting a 30% by weight of platinum fine particles on a carbon carrier and polyperfluorosulfonic acid in a mixed solvent of 1-propanol, 2-propanol and methoxyethanol as a binder in a water/alcohol mixed solvent was prepared, and using this slurry a cathode electrode of about 20 μm in thickness, 30 mm in width and 30 mm in length was formed on a polyimide film by screen printing method. After about 0.5 ml of a solution of 5% by weight of the above polymer electrolyte in a mixed solvent of 1-propanol, 2-propanol and methoxyethanol was penetrated through the surface of the anode electrode, the anode electrode was bonded to the sulfomethylated polyether sulfone electrolyte film produced in the above (4), followed by applying a load of about 1 kg and drying at 80° C. for 3 hours.

Then, about 0.5 ml of a solution of 5% by weight of polyperfluorosulfonic acid in a mixed solvent of 1-propanol, 2-propanol and methoxyethanol was penetrated through the surface of the cathode electrode, and the cathode electrode was bonded to the above electrolyte film in such a manner that it overlapped the previously bonded anode layer, followed by applying a load of about 1 kg and drying at 80° C. for 3 hours to produce MEA (I).

An aqueous dispersion of water repellant polytetrafluoroethylene (PTFE) fine particles (Dispersion D-1 manufactured by Daikin Kogyo Co., Ltd.) were added to a carbon powder so as to give 40% by weight after firing, followed by kneading to obtain a paste. This paste was coated on a carbon cloth of about 350 μm in thickness and 87% in porosity, dried at room temperature, and then fired at 270° C. for 3 hours to form a carbon sheet. The amount of PTFE was 5-20% by weight based on the weight of the carbon cloth. The resulting sheet was cut to the same shape and size as the electrode of the above MEA to obtain a cathode diffusion layer. A carbon cloth of about 350 μm in thickness and 87% in porosity was dipped in fuming sulfuric acid (60% in concentration) and kept at 60° C. for 2 days in nitrogen stream. Then, the temperature of the flask was cooled to room temperature. The fuming sulfuric acid was removed, and the carbon cloth was washed well until the distilled water became neutral.

Then, the carbon cloth was impregnated with methanol and dried. In infrared spectroscopic absorption spectrum of the resulting carbon cloth, absorptions based on —OSO₃H group were recognized at 1225 cm⁻¹ and 1413 cm⁻¹. Further, an absorption based on —OH group was recognized at 1049 cm⁻¹. Thus, it was confirmed that —OSO₃H group and —OH group were introduced into the surface of the carbon cloth. The contact angle of aqueous methanol solution with the carbon cloth which was not subjected to the treatment with fuming sulfuric acid was smaller than 81°, and the carbon cloth was hydrophilic. Moreover, the carbon cloth was superior also in electric conductivity. The carbon cloth was cut to the same shape and size as the electrode of the above MEA (I) to obtain an anode diffusion layer.

(6) Electricity generation performance of fuel cell (DMFC):

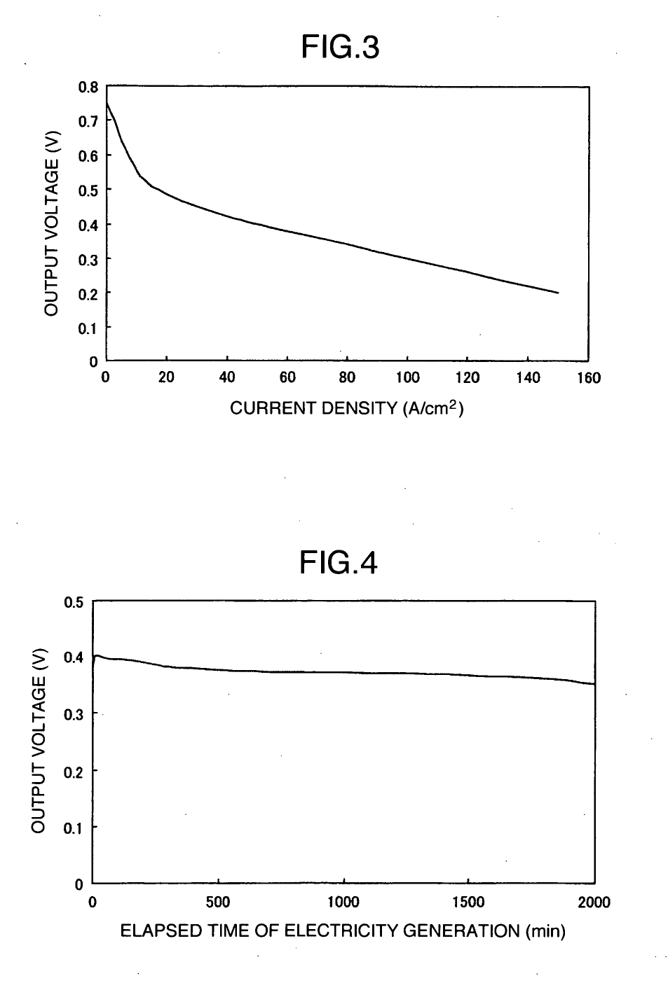

Using the monocell of the polymer fuel cell electricity generation device shown in FIG. 2 in which the above MEA (I) having the above diffusion layers was incorporated, cell performance was evaluated. In FIG. 2, 1 indicates a polymer electrolyte film, 2 indicates an anode electrode, 3 indicates a cathode electrode, 4 indicates an anode diffusion layer, 5 indicates a cathode diffusion layer, 6 indicates an anode current collector, 7 indicates a cathode current collector, 8 indicates a fuel, 9 indicates air, 10 indicates an anode terminal, 11 indicates a cathode terminal, 12 indicates an anode terminal plate, 13 indicates a cathode terminal plate, 14 indicates a gasket, 15 indicates an O-ring, and 16 indicates bolt/nut. As a fuel, an aqueous methanol solution of 20% by weight in concentration was circulated to the anode, and air was fed to the cathode. Continuous operation was conducted at 30° C. under application of a load of 50 mA/cm². FIG. 3 shows a current-voltage characteristic after 10 hours from starting of the operation. The output voltage was 0.4 V at 50 mA/cm². Successively, the continuous operation was conducted at 30° C. under application of a load of 50 mA/cm². The change with time of the output voltage is shown in FIG. 4. The DMFC showed an output of 0.35 V after operation for 2,000 hours, and thus was stable.

### Comparative Example 1

(1) Production of film electrode junction (MEA):

A slurry of a catalyst powder prepared by dispersing and supporting, on a carbon carrier, 50% by weight of platinum/ruthenium alloy fine particles having an atomic ratio of platinum and ruthenium of 1/1 and a solution of 30% by weight of polyperfluorosulfonic acid electrolyte as a binder in a water/alcohol mixed solvent (a mixed solvent of water, isopropanol and n-propanol at a weight ratio of 20:40:40) was prepared, and using this slurry an anode electrode of about 125 μm in thickness, 30 mm in width and 30 mm in length was formed on a polyimide film by screen printing method.

Then, a slurry of a catalyst powder comprising 30% by weight of platinum fine particles supported on a carbon carrier and 30% by weight of polyperfluorosulfonic acid as a binder in a water/alcohol mixed solvent was prepared, and using this slurry a cathode electrode of about 20 μm in thickness, 30 mm in width and 30 mm in length was formed on a polyimide film by screen printing method. After about 0.5 ml of an alcoholic aqueous solution of 5% by weight of polyperfluorosulfonic acid (a mixed solvent of water, isopropanol and n-propanol at a weight ratio of 20:40:40) was penetrated through the surface of the anode electrode, the anode electrode was bonded to the sulfomethylated polyether sulfone electrolyte film produced in the above (4) of Example 1, followed by drying at 80° C. for 3 hours with application of a load of about 1 kg.

Then, about 0.5 ml of a solution of 5% by weight of polyperfluorosulfonic acid in a mixed solvent of 1-propanol, 2-propanol and methoxyethanol was penetrated through the surface of the cathode electrode, and the cathode electrode was bonded to the above polymer electrolyte film in contact with the previously bonded anode layer, followed by drying at 80° C. for 3 hours with applying a load of about 1 kg to produce MEA (II).

The hydrophilic carbon cloth produced in Example 1 was used as an anode diffusion layer and the water repellent carbon cloth produced in Example 1 were used in the above MEA (II).

(2) Electricity generation performance of fuel cell (DMFC):

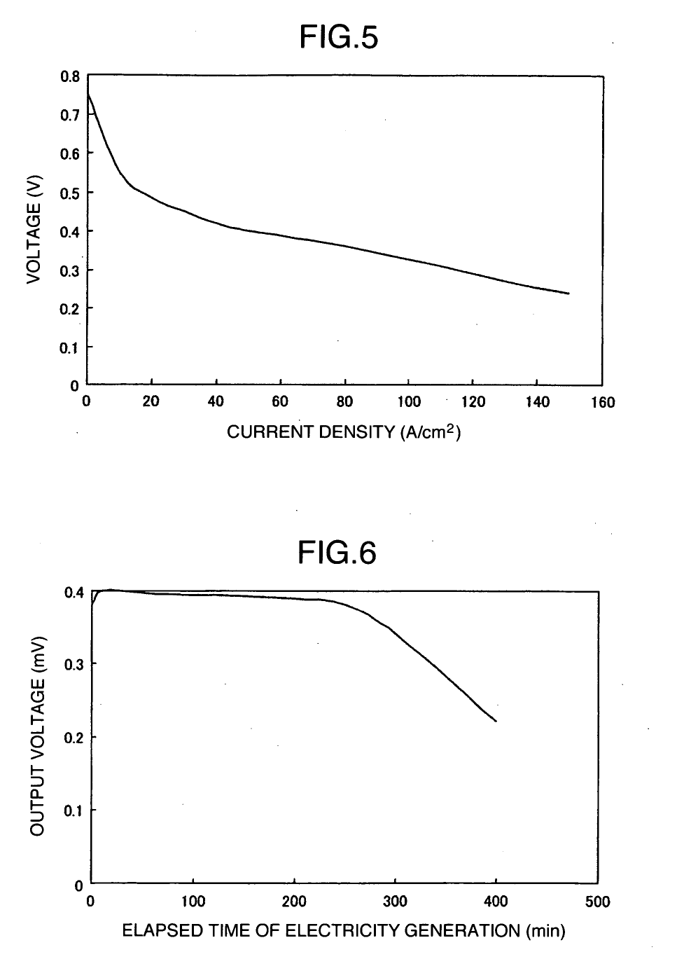

Using the monocell of the polymer fuel cell electricity generation device shown in FIG. 2 in which the above MEA (II) having the above diffusion layers were incorporated, cell performance was evaluated. As a fuel, an aqueous methanol solution of 20% by weight in concentration was circulated to the anode, and air was fed to the cathode. Continuous operation was carried out at 30° C. under application of a load of 50 mA/cm². FIG. 5 shows a current-voltage characteristic after 10 hours from starting of the operation. The output voltage was 0.4 V at 50 mA/cm². Successively, the continuous operation was carried out at 30° C. under application of a load of 50 mA/cm². The change with time of the output voltage is shown in FIG. 6. The output voltage decreased to 0.22 V after operation for 400 hours.

From the above, it can be seen that the fuel cell in which MEA using a hydrocarbon electrolyte as a polymer electrolyte binder of the anode electrode and a fluorine-containing electrolyte as a polymer electrolyte binder of the cathode electrode can provide stable output for a long period of time, being different from the fuel cell in which MEA using a fluorine-containing electrolyte as a polymer electrolyte binder of the anode electrode and the cathode electrode.

Comparative Example 2

(1) Production of film electrode junction (MEA):

A MEA (III) was produced in the same manner as in Example 1, except that the polymer electrolyte of the cathode electrode was changed to a hydrocarbon electrolyte which was sulfomethylated polyether sulfone having a sulfomethyl group introduction rate {the proportion of structural units into which sulfomethyl group was introduced to all structural units (total of x and y) in (formula 2)} of 41% mentioned in (5) of Example 1, and the polymer electrolyte in bonding the cathode electrode to the polymer electrolyte film was changed to a hydrocarbon electrolyte which was sulfomethylated polyether sulfone having a sulfomethyl group introduction rate {the proportion of structural units into which sulfomethyl group was introduced to all structural units (total of x and y) in (formula 2)} of 41% mentioned in (5) of Example 1.

(2) Electricity generation performance of fuel cell (DMFC):

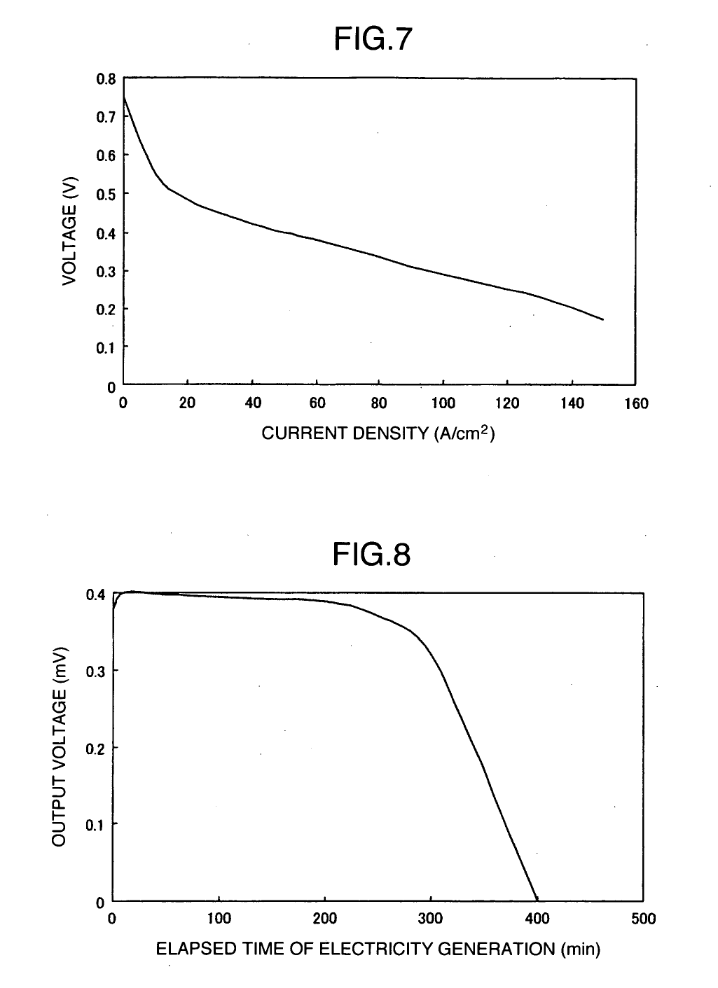

Cell performance was evaluated using the monocell of the polymer fuel cell electricity generation device shown in FIG. 2 in which the above MEA (III) having the above diffusion layers was incorporated. As a fuel, an aqueous methanol solution of 20% by weight in concentration was circulated to the anode, and air was fed to the cathode. Continuous operation was carried out at 30° C. under application of a load of 50 mA/cm². FIG. 7 shows a current-voltage characteristic after 10 hours from starting of the operation. The output voltage was 0.4 V at 50 mA/cm². Successively, the continuous operation was carried out at 30° C. under application of a load of 50 mA/cm². The change with time of the output voltage is shown in FIG. 8. The output voltage decreased to 0 V after operation for 400 hours.

From the above, it can be seen that the fuel cell in which MEA using a hydrocarbon electrolyte as a polymer electrolyte binder of the anode electrode and a fluorine-containing electrolyte as a polymer electrolyte binder of the cathode electrode can provide stable output for a long period of time, being different from the fuel cell in which MEA using a hydrocarbon electrolyte as a polymer electrolyte binder of the anode electrode and the cathode electrode.

### Example 2

A film electrode junction (MEA) was produced in the same manner as in Example 1, except that the thickness of the cathode electrode was 10 μm, and this was incorporated in the monocell shown in FIG. 2, and a continuous operation was carried out at 30° C. under application of a load of 50 mA/cm². As a result, the output after continuous operation for 10 hours was 0.41 V, and the output after continuous operation for 2,000 hours was 0.34 V. It can be seen that the initial output of MEA in which the thickness of the cathode electrode was 10 μm was higher than that of MEA in which the thickness of the cathode electrode was 20 μm, but rather decreased after lapse of a long time.

### Example 3-Example 6

(1) Preparation of carbon paper subjected to hydrophilic treatment:

A carbon paper of about 150 μm in thickness and 87% in porosity was dipped in fuming sulfuric acid (60% in concentration) and kept at 60° C. for 2 days in nitrogen stream. Then, the temperature of the flask was cooled to room temperature. The fuming sulfuric acid was removed, and the carbon paper was washed well until the distilled water became neutral. Then, the carbon paper was dipped in methanol and dried. In infrared spectroscopic absorption spectrum of the resulting hydrophilic carbon paper 1, absorptions based on —OSO₃H group were recognized at 1225 cm⁻¹ and 1413 cm⁻¹. Further, an absorption based on —OH group was recognized at 1049 cm⁻¹. Thus, it was confirmed that —OSO₃H group and —OH group were introduced into the surface of the carbon paper. The contact angle of aqueous methanol solution with the carbon paper which was not subjected to the treatment with fuming sulfuric acid was smaller than 81°, and the carbon paper was hydrophilic. Moreover, the carbon paper was superior also in electric conductivity.

(2) Production of film electrode junction (MEA):

Film electrode junctions (MEA) were produced in the same manner as in Example 1, except that the above hydrophilic carbon paper 1 was used as the diffusion layer of the anode and the thickness of the cathode electrode was 5, 10, 20 and 50 μm as shown in Table 2.

(3) Electricity generation performance of fuel cell (DMFC):

Cell performance was evaluated using the monocell of the polymer fuel cell electricity generation device shown in FIG. 2 in which the above MEA having the diffusion layers was incorporated. As a fuel, an aqueous methanol solution of 20% by weight in concentration was circulated to the anode, and air was fed to the cathode. Continuous operation was carried out at 30° C. under application of a load of 50 mA/cm². The output voltages at a load of current density of 50 mA/cm² after 10 hours and 2000 hours from the starting of the operation are shown in Table 1.

The thinner the cathode electrode, the better the electricity generation output just after the starting of the operation. On the other hand, the output after 2,000 hours had a tendency to decrease when the cathode electrode was thin. The thickness of the cathode electrode is preferably from 20 to 50 μm.

TABLE 1

| | | Example 3 | Example 4 | Example 5 | Example 6 |
|---|---|---|---|---|---|
| Anode | Hydrophilic | Hydrophilic | Hydrophilic | Hydrophilic | Hydrophilic |
| | treatment | treatment | treatment | treatment | treatment |
| | Carbon paper | Carbon paper | Carbon paper | Carbon paper | Carbon paper |
| | 125 μm | 125 μm | 125 μm | 125 μm | 100 μm |
| | SM-PES*³ | SM-PES*³ | SM-PES*³ | SM-PES*³ | SP-PPS*⁸ |
| Polymer electrolyte film | | SM-PES*³ | SM-PES*³ | SM-PES*³ | SM-PES*³ |
| Cathode | Nafion*⁴ | Nafion*⁴ | Nafion*⁴ | Nafion*⁴ | Nafion*⁴ |
| | 5 μm | 10 μm | 20 μm | 50 μm | 15 μm |
| | Water repellent | Water repellent | Water repellent | Water repellent | Water repellent |
| | treatment | treatment | treatment | treatment | treatment |
| | Carbon cloth | Carbon cloth | Carbon cloth | Carbon cloth | Carbon cloth |

| | | | | |
|---|---|---|---|---|
| Output*¹ (mV at 50 mA/cm²) | 0.43 | 0.42 | 0.40 | 0.40 |
| Output*² (mV at 50 mA/cm²) | 0.32 | 0.36 | 0.38 | 0.34 |

*¹After 10 hours from starting of generation of electricity.
*²After 2,000 hours from starting of generation of electricity.
*³Sulfomethylated polyether sulfone
*⁴Polyperfluorosulfonic acid.

### Example 7-Example 10

(1) Production of polyolefin porous film:

A solution of a polyethylene composition was prepared by mixing starting resins comprising a mixture of 3 parts by weight of ultra-high molecular weight polyethylene having a weight average molecular weight of 2.5×10⁶ and 14 parts by weight of high-density polyethylene having a weight average molecular weight of 6.8×10⁵ with 83 parts by weight of liquid paraffin. Then, 100 parts by weight of this solution of polyethylene composition was mixed with 0.375 part by weight of an antioxidant. The resulting mixture was charged in an autoclave with a stirrer and stirred at 200° C. for 90 minutes to obtain a uniform solution. This solution was extruded from a T-die at 200° C. by an extruder of 45 mm in diameter and taken off by a cooling roll cooled to 20° C. to form a gel-like sheet of 1.8 mm in thickness. The resulting sheet was set at a biaxial stretching machine and subjected to simultaneous biaxial stretching to 5×5 times at a temperature of 105° C. and a film forming rate of 5 m/min.

The resulting stretched film was washed with methylene chloride to extract and remove the remaining liquid paraffin. The film was dried at room temperature and then subjected to hot fixation treatment at 90° C. for 30 seconds to obtain a polyolefin porous film 1 having a thickness of 20 μm and a porosity of 40%. The porosity was calculated from weight W (g) per unit area S (cm²) of the film, average thickness t (μm), and density d (g/cm³) by the following formula [1].
Porosity (%)=(1−(10⁴×W/S/t/d))×100 [1]

The heat shrinkage of this polyolefin porous film 1 was measured on a sample of 10 cm square which was left to stand in the strainless state at 105° C. for 8 hours to obtain a heat shrinkage in the lengthwise direction of 25% and a heat shrinkage in the widthwise direction of 19%.

(2) Formation of polymer electrolyte composite film:

Before formation of the polymer electrolyte composite film, the sulfomethylated polyether sulfone electrolyte prepared in (3) of Example 1 was dissolved in N,N-dimethylacetamide to prepare a 25 wt % polymer electrolyte solution. The above polyolefin porous film 1 was impregnated with the resulting solution, and the polymer electrolyte solution was cast and coated on a glass substrate, followed by drying by heating at 80° C. for 30 minutes and at 120° C. for 30 minutes to remove the solvent in the solution, thereby forming a polymer electrolyte composite film 1 which comprised the polyolefin porous film 1 coated with sulfomethylated polyether sulfone electrolyte on both sides and in which the pores in the polyolefin porous film 1 was filled with the sulfomethylated polyether sulfone. The thickness of the resulting polymer electrolyte composite film 1 was 40 μm.

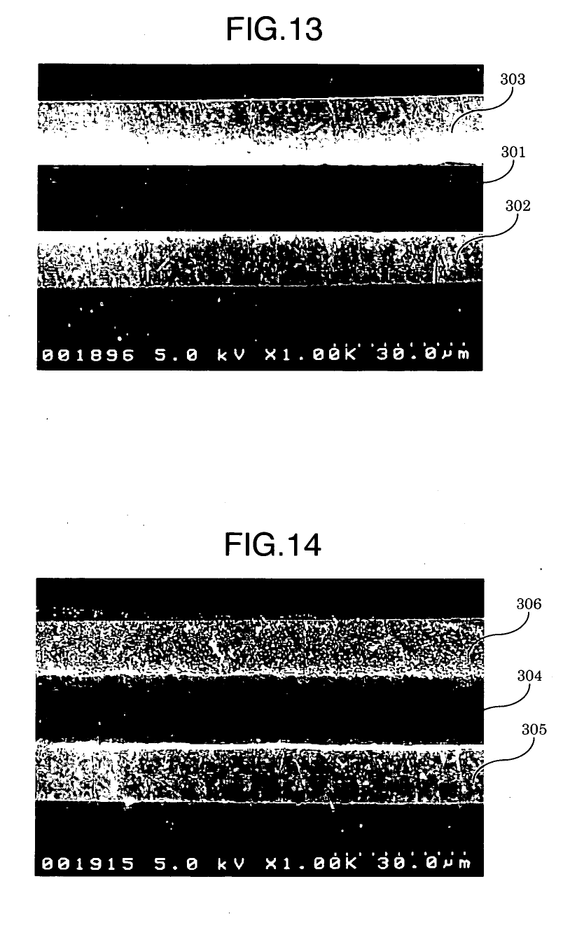

An SEM sectional photograph of the resulting polymer electrolyte composite film 1 is shown in FIG. 13. In the photograph, 301 indicates a polyolefin porous film layer filled with sulfomethylated polyether sulfone, 302 indicates an anode side electrolyte film layer (sulfomethylated polyether sulfone electrolyte film layer), and 303 indicates a cathode side electrolyte film layer (sulfomethylated polyether sulfone electrolyte film layer).

(3) Production of carbon paper subjected to hydrophilic treatment:

One part by weight of polyethylene glycol having a molecular weight of 20,000 was added to 297 parts by weight of tetrahydrofuran, followed by stirring while heating at 50° C. to dissolve polyethylene glycol. Two parts by weight of Sila-Ace S330 manufacture by Chisso Corporation having both amino group and alkoxysilane residue was added to the solution, and the solution was stirred to prepare a paint for forming a hydrophilic coating film. A carbon paper of about 150 μm in thickness and 87% in porosity subjected to oxygen plasma treatment was dipped in the above paint for about 5 minutes, and then the carbon paper was taken out from the paint and heat treated at 100° C. for 20 minutes to obtain a hydrophilic carbon paper 2.

(4) Production of film electrode junction (MEA):

A film electrode junction (MEA) was produced in the same manner as in Example 3, except that the polymer electrolyte composite film 1 was used as the polymer electrolyte film and the hydrophilic carbon paper 2 was used as the anode diffusion layer.

(5) Electricity generation performance of fuel cell (DMFC):

Cell performance was evaluated using the monocell of the polymer fuel cell electricity generation device shown in FIG. 2 in which the above MEA having the diffusion layers was incorporated. As a fuel, an aqueous methanol solution of 20% by weight in concentration was circulated to the anode, and air was fed to the cathode. Continuous operation was carried out at 30° C. under application of a load of 50 mA/cm². The output voltages at a load of current density of 50 mA/cm² after 10 hours and 2000 hours from the starting of the operation are shown in Table 2.

The thinner the cathode electrode, the better the electricity generation output just after the starting of the operation. On the other hand, the output after 2,000 hours had a tendency to decrease when the cathode electrode was thin. The thickness of the cathode electrode is preferably 15-50 μm.

When Table 1 and Table 2 are compared, it can be seen that the polymer electrolyte composite film is superior as the polymer electrolyte film.

TABLE 2

| | | Example 7 | Example 8 | Example 9 | Example 10 |
|---|---|---|---|---|---|
| Anode | Diffusion | Hydrophilic | Hydrophilic | Hydrophilic | Hydrophilic |
| | layer | treatment | treatment | treatment | treatment |
| | | Carbon paper | Carbon paper | Carbon paper | Carbon paper |
| | Thickness of | 125 μm | 125 μm | 100 μm | 100 μm |
| | electrode | | | | |
| | Polymer | SM-PES*³ | SM-PES*³ | SM-PES*³ | SP-PPS*⁸ |
| | electrolyte | | | | |
| Polymer electrolyte film | | Composite film | Composite film | Composite film | Composite film |
| Cathode | Polymer | Nafion*⁴ | Nafion*⁴ | Nafion*⁴ | Nafion*⁴ |
| | electrolyte | | | | |
| | Thickness of | 10 μm | 20 μm | 50 μm | 15 μm |
| | electrode | | | | |
| | Diffusion | Water repellent | Water repellent | Water repellent | Water repellent |
| | layer | treatment | treatment | treatment | treatment |
| | | Carbon cloth | Carbon cloth | Carbon cloth | Carbon cloth |

| | | | | |
|---|---|---|---|---|
| Output*¹ (mV at 50 mA/cm²) | 0.44 | 0.43 | 0.42 | 0.41 |
| Output*² (mV at 50 mA/cm²) | 0.36 | 0.39 | 0.40 | 0.38 |

*¹After 10 hours from starting of generation of electricity.
*²After 2,000 hours from starting of generation of electricity.
*³Sulfomethylated polyether sulfone.
*⁴Polyperfluorosulfonic acid.

### Example 11-Example 14

The results as shown in Table 3 were obtained by carrying out the same experiment as in Example 6, except that a carbon paper 2 subjected to water repellent treatment was used as the anode diffusion layer and the thickness of the anode electrode and the cathode electrode was changed as shown in Table 3. From Table 3, it can be seen that the greater thickness of the anode electrode is preferred, and particularly, 100-150 μm is preferred.

TABLE 3

| | | Example 11 | Example 12 | Example 13 | Example 14 |
|---|---|---|---|---|---|
| Anode | Diffusion | Hydrophilic | Hydrophilic | Hydrophilic | Hydrophilic |
| | layer | treatment | treatment | treatment | treatment |
| | | Carbon paper | Carbon paper | Carbon paper | Carbon paper |
| | Thickness of | 100 μm | 150 μm | 200 μm | 100 μm |
| | electrode | | | | |
| | Polymer | SM-PES*³ | SM-PES*³ | SM-PES*³ | SP-PPS*⁸ |
| | electrode | | | | |
| Polymer electrolyte film | | Composite film | Composite film | Composite film | Composite film |
| Cathode | Polymer | Nafion*⁴ | Nafion*⁴ | Nafion*⁴ | Nafion*⁴ |
| | electrolyte | | | | |
| | Thickness of | 15 μm | 15 μm | 15 μm | 15 μm |
| | electrode | | | | |
| | Diffusion | Water repellent | Water repellent | Water repellent | Water repellent |
| | layer | treatment | treatment | treatment | treatment |
| | | Carbon paper | Carbon paper | Carbon paper | Carbon cloth |

| | | | | |
|---|---|---|---|---|
| Output*¹ (mV at 50 mA/cm²) | 0.40 | 0.43 | 0.45 | 0.46 |
| Output*² (mV at 50 mA/cm²) | 0.39 | 0.40 | 0.41 | 0.42 |

*¹After 10 hours from starting of generation of electricity.
*²After 2,000 hours from starting of generation of electricity.
*³Sulfomethylated polyether sulfone.
*⁴Polyperfluorosulfonic acid.

### Example 15 and Example 16

Preparation of polymer electrolyte binder:

[Preparation of sulfopropylated polyether sulfone]

The inside of a four-necked round flask of 500 ml equipped with a stirrer, a thermometer, and a reflux condenser having a calcium chloride tube was replaced with nitrogen, and then 21.6 g of polyether sulfone (PES), 12.2 g (0.1 mol) of propanesultone and 50 ml of dried nitrobenzene were charged in the flask. While stirring, 14.7 g (0.11 mol) of anhydrous aluminum chloride was added thereto over a period of about 30 minutes. After completion of addition of anhydrous aluminum chloride, reflux was carried out for 8 hours.

Then, the reaction product was poured in 500 milliliters of ice water to which 25 milliliters of concentrated hydrochloric acid was added, thereby to stop the reaction. The reaction mixture was gradually dropped in 1 liter of deionized water to precipitate sulfopropylated polyether sulfone, which was filtered off and recovered. The precipitate was repeatedly subjected to washing with deionized water by a mixer and recovery operation by suction filtration until the filtrate became neutral, and then vacuum dried overnight at 120° C. The ion exchange group equivalent of the resulting sulfopropylated polyether sulfone (SP-PES) was 1.1 meq/g.

[Preparation of sulfobutylated polyether sulfone]

The inside of a four-necked round flask of 500 ml equipped with a stirrer, a thermometer, and a reflux condenser having a calcium chloride tube was replaced with nitrogen, and then 21.6 g of polyether sulfone (PES), 13.6 g (0.1 mol) of butanesultone and 50 ml of dried nitrobenzene were charged in the flask. While stirring, 14.7 g (0.11 mol) of anhydrous aluminum chloride was added thereto over a period of about 30 minutes. After completion of addition of anhydrous aluminum chloride, reflux was carried out for 8 hours. Then, the reaction product was poured in 500 milliliters of ice water to which 25 milliliters of concentrated hydrochloric acid was added to stop the reaction. The reaction mixture was gradually dropped in 1 liter of deionized water to precipitate sulfobutylated polyether sulfone, which was filtered off and recovered. The precipitate was repeatedly subjected to washing with deionized water by a mixer and recovery operation by suction filtration until the filtrate became neutral, and then vacuum dried overnight at 120° C. The ion exchange group equivalent of the resulting sulfobutylated polyether sulfone (SB-PES) was 1.1 meq/g.

[Preparation of sulfohexamethylated polyether sulfone]

The inside of a four-necked round flask of 500 ml equipped with a stirrer, a thermometer, and a reflux condenser having a calcium chloride tube was replaced with nitrogen, then 23.2 g of polyether sulfone (PES) and 50 ml of dried nitrobenzene were charged in the flask. Thereto was added 6.5 g of n-butoxylithium, and the mixture was kept at room temperature for 2 hours, followed by adding 100 g of 1,6-dibromohexane and further stirring for 12 hours. The reaction mixture was slowly dropped in 1 liter of deionized water to precipitate bromohexamethylated polyether sulfone, which was filtered off and recovered. The precipitate was repeatedly subjected to washing with deionized water by a mixer and recovery operation by suction filtration until the filtrate became neutral, and then vacuum dried overnight at 120° C.

The inside of a four-necked round flask of 500 ml equipped with a stirrer, a thermometer, and a reflux condenser having a calcium chloride tube was replaced with nitrogen, and then 10 g of the above bromohexamethylated polyether sulfone, 50 ml of dried nitrobenzene and 30 g of sodium sulfate were charged in the flask, followed by stirring at 100° C. for 5 hours. Furthermore, 10 milliliters of ion exchanged water was added, followed by stirring for 5 hours.

Then, the reaction mixture was slowly dropped in 1 liter of deionized water to precipitate sulfohexamethylated polyether sulfone (SHM-PES), which was filtered off and recovered. The precipitate was repeatedly subjected to washing with deionized water by a mixer and recovery operation by suction filtration until the filtrate became neutral, and then vacuum dried overnight at 120° C. The ion exchange group equivalent of the resulting sulfohexamethylated polyether sulfone (SHM-PES) was 1.4 meq/g.

[Preparation of sulfopropylated polyphenylene sulfide]

The inside of a four-necked round flask of 500 ml equipped with a stirrer, a thermometer, and a reflux condenser having a calcium chloride tube was replaced with nitrogen, and then 10.8 g of polyphenylene sulfide (PPS), 12.2 g (0.1 mol) of propanesultone and 50 ml of dried acetophenone were charged in the flask. While stirring, 14.7 g (0.11 mol) of anhydrous aluminum chloride was added thereto over a period of about 30 minutes. After completion of the addition of anhydrous aluminum chloride, reflux was carried out for 10 hours. Then, the reaction mixture was gradually dropped in 0.5 liter of deionized water to precipitate sulfopropylated polyphenylene sulfide, which was filtered off and recovered. The precipitate was repeatedly subjected to washing with deionized water by a mixer and recovery operation by suction filtration until the filtrate became neutral, and then vacuum dried overnight at 120° C. The ion exchange group equivalent of the resulting sulfopropylated polyphenylene sulfide (SP-PPS) was 1.6 meq/g.

(2) Production of polymer electrolyte film:

The hydrocarbon electrolyte obtained in the above (1) was dissolved in a mixed solvent (1:1) of dimethylacetamide-methoxyethanol so as to give a concentration of 5% by weight. This solution was spread on a glass by spin coating, and air-dried and then vacuum dried at 80° C. to obtain a hydrocarbon electrolyte film having a thickness of about 40 μm.

(3) Production of film electrode junction (MEA):

A film electrode junction (MEA) was produced in the same manner as in Example 3, except that the polymer electrolyte film of the above (2) was used as the polymer electrolyte film, and the polymer electrolyte of the above (1) was used as the polymer electrolyte of the anode electrode.

(4) Electricity generation performance of fuel cell (DMFC):

Cell performance was evaluated using the monocell of the polymer fuel cell electricity generation device shown in FIG. 2 in which the above MEA having the diffusion layers was incorporated. As a fuel, an aqueous methanol solution of 20% by weight in concentration was circulated to the anode, and air was fed to the cathode. Continuous operation was carried out at 30° C. under application of a load of 50 mA/cm². The output voltages at a load of current density of 50 mA/cm² after 10 hours and 2,000 hours from the starting of the operation are shown in Table 4.

As can be seen from the above, the longer the length of methylene group of sulfoalkyl group, the better the characteristics as the polymer electrolyte.

TABLE 4

| | | Example 15 | Example 16 | Example 17 | Example 18 |
|---|---|---|---|---|---|
| Anode | Diffusion | Hydrophilic | Hydrophilic | Hydrophilic | Hydrophilic |
| | layer | treatment | treatment | treatment | treatment |
| | | Carbon paper | Carbon paper | Carbon paper | Carbon paper |
| | Thickness of | 125 μm | 125 μm | 125 μm | 100 μm |
| | electrode | | | | |
| | Polymer | SP-PES*⁵ | SB-PES*⁶ | SHM-PES*⁷ | SP-PPS*⁸ |
| | electrolyte | | | | |
| Polymer electrolyte film | | SP-PES*⁵ | SB-PES*⁶ | SHM-PES*⁷ | SP-PPS*⁸ |
| Cathode | Polymer | Nafion*⁴ | Nafion*⁴ | Nafion*⁴ | Nafion*⁴ |
| | electrolyte | | | | |
| | Thickness of | 20 μm | 20 μm | 15 μm | 15 μm |
| | electrode | | | | |
| | Diffusion | Water repellent | Water repellent | Water repellent | Water repellent |
| | layer | treatment | treatment | treatment | treatment |
| | | Carbon cloth | Carbon cloth | Carbon cloth | Carbon cloth |

| | | | | |
|---|---|---|---|---|
| Output*¹ (mV at 50 mA/cm²) | 0.45 | 0.47 | 0.49 | 0.42 |
| Output*² (mv at 50 mA/cm²) | 0.40 | 0.41 | 0.42 | 0.33 |

*¹After 10 hours from starting of generation of electricity.
*²After 2,000 hours from starting of generation of electricity.
*³Sulfomethylated polyether sulfone.
*⁴Polyperfluorosulfonic acid.
*⁵Sulfopropylated polyether sulfone.
*⁶Sulfobutylated polyether sulfone.
*⁷Sulfohexamethylated polyether sulfone.
*⁸Sulfopropylated polysulfide

### Example 19-Example 22

(1) Preparation of polymer electrolyte binder:

The inside of a four-necked round flask of 500 ml equipped with a stirrer, a thermometer, a nitrogen introduction pipe and a reflux condenser was replaced with nitrogen, and then 25 g of polyether sulfone (PES) and 125 ml of concentrated sulfuric acid were charged in the flask. In a nitrogen stream, stirring was carried out at room temperature overnight to prepare a uniform solution. In a nitrogen stream, 48 ml of chlorosulfuric acid was dropped in the resulting solution from a dropping funnel while stirring. Since after starting of the dropping, chlorosulfuric acid vigorously reacted with water in the concentrated sulfuric acid to cause bubbling, the dropping was carried out slowly, and after the bubbling became gentle, the dropping was terminated in 5 minutes. The reaction mixture after completion of dropping was stirred at 25° C. for 4 hours to perform sulfonation.

Then, the reaction mixture was gradually dropped in 15 liters of deionized water to precipitate sulfonated polyether sulfone, which was filtered off and recovered. The precipitate was repeatedly subjected to washing with deionized water by a mixer and recovery operation by suction filtration until the filtrate became neutral, and then vacuum dried overnight at 80° C. The ion exchange group equivalent of the resulting sulfonated polyether sulfone was 1.14 meq/g.

(2) Formation of polymer electrolyte composite film:

Before formation of the polymer electrolyte composite film, the sulfonated polyether sulfone electrolyte binder prepared in (3) of Example 1 was dissolved in N-methylpyrrolidone to prepare a solution of 30% by weight in concentration. The polyolefin porous film 1 prepared in Example 7 was impregnated with the resulting solution, and the polymer electrolyte solution was cast and coated on a glass substrate, followed by drying by heating at 80° C. for 30 minutes and at 120° C. for 30 minutes to remove the solvent in the solution, thereby forming a polymer electrolyte composite film 2 which comprised the polyolefin porous film 1 coated with sulfomethylated polyether sulfone electrolyte on both sides and in which the pores in the polyolefin porous film 1 was filled with the sulfomethylated polyether sulfone electrolyte. The thickness of the resulting polymer electrolyte composite film 2 was 40 μm.

(3) Production of film electrode junction (MEA):

A film electrode junction (MEA) was produced in the same manner as in Example 3, except that the polymer electrolyte composite film 2 was used as the polymer electrolyte film, and the above carbon paper 2 subjected to hydrophilic treatment was used as the anode diffusion layer.

(4) Electricity generation performance of fuel cell (DMFC):

Cell performance was evaluated using the monocell of the polymer fuel cell electricity generation device shown in FIG. 2 in which the above MEA having the diffusion layers was incorporated. As a fuel, an aqueous methanol solution of 20% by weight in concentration was circulated to the anode, and air was fed to the cathode. Continuous operation was carried out at 30° C. under application of a load of 50 mA/cm². The output voltages at a load of current density of 50 mA/cm² after 10 hours and 2,000 hours from the starting of the operation are shown in Table 5.

The sulfoalkylated polyether sulfones were superior to the sulfonated polyether sulfones as the polymer electrolyte binder of anode electrode. It can be seen that as the sulfoalkylated polyether sulfones, those which are greater in the number of methylene groups are superior.

TABLE 5

| | | Example 19 | Example 20 | Example 21 | Example 22 |
|---|---|---|---|---|---|
| Anode | Diffusion | Hydrophilic | Hydrophilic | Hydrophilic | Hydrophilic |
| | layer | treatment | treatment | treatment | treatment |
| | | Carbon paper | Carbon paper | Carbon paper | Carbon paper |
| | Thickness of | 125 μm | 125 μm | 125 μm | 100 μm |
| | electrode | | | | |
| | Polymer | SM-PES*³ | SB-PES*³ | SHM-PES*³ | S-PES*⁹ |
| | electrolyte | | | | |
| Polymer electrolyte film | | S-PES | S-PES | S-PES | S-PES |
| | | Composite | Composite | Composite | Composite |
| | | film*¹⁰ | film*¹⁰ | film*¹⁰ | film*¹⁰ |
| Cathode | Polymer | Nafion*⁴ | Nafion*⁴ | Nafion*⁴ | Nafion*⁴ |
| | electrolyte | | | | |
| | Thickness of | 15 μm | 15 μm | 15 μm | 15 μm |
| | electrode | | | | |
| | Diffusion | Water repellent | Water repellent | Water repellent | Water repellent |
| | layer | treatment | treatment | treatment | treatment |
| | | Carbon cloth | Carbon cloth | Carbon cloth | Carbon cloth |

| | | | | |
|---|---|---|---|---|
| Output*¹ (mV at 50 mA/cm²) | 0.43 | 0.44 | 0.45 | 0.43 |
| Output*² (mv at 50 mA/cm²) | 0.39 | 0.40 | 0.41 | 0.35 |

*¹After 10 hours from starting of generation of electricity.
*²After 2,000 hours from starting of generation of electricity.
*³Sulfomethylated polyether sulfone.
*⁴Polyperfluorosulfonic acid.
*⁹Sulfonated polyether sulfone.
*¹⁰Sulfonated polyether sulfone composite film.

### Example 23

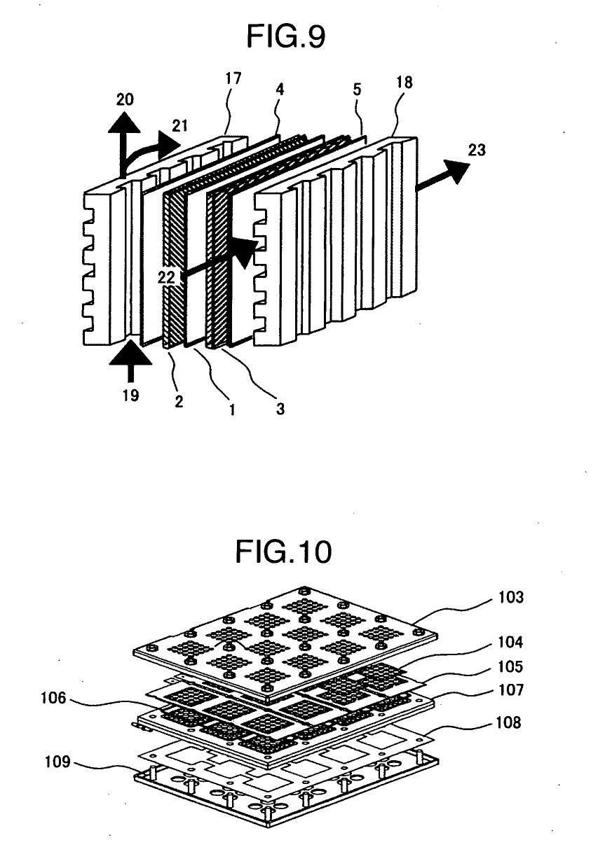

Using the small monocell which used hydrogen as a fuel shown in FIG. 2 in which the above MEA (I) of Example 1 having the diffusion layers was incorporated, cell performance was evaluated. In FIG. 9, 1 indicates a polymer electrolyte film, 2 indicates an anode electrode, 3 indicates a cathode electrode, 4 indicates an anode diffusion layer, 5 indicates a cathode diffusion layer, 17 indicates a fuel flow path of a conductive separator (bipolar plate) which serves as separator of electrode chamber and as gas feeding path to electrode, 18 indicates an air flow path of a conductive separator (bipolar plate) which serves as separator of electrode chamber and as gas feeding path to electrode, 19 indicates hydrogen as a fuel and water, 20 indicates hydrogen, 21 indicates water, 22 indicates air, and 23 indicates air and water. The small monocell was placed in a thermostatic chamber, and the temperature of the thermostatic chamber was controlled so that the temperature measured by a thermocouple (not shown) inserted in the separator was kept at 70° C.

Humidification of the anode and cathode was carried out using an external humidifier, and the temperature of the humidifier was controlled between 70-73° C. so that the dew point at around the outlet of the humidifier reached 70° C. In addition to measurement of dew point by a dew point recorder, it was confirmed that the dew point obtained from the flow rate, temperature and pressure of the reaction gas was a given value by regularly measuring the consumption amount of humidification water. The loaded current density was 250 mA/cm², hydrogen utilization rate was 70%, air utilization rate was 40%, and electricity generation was carried out at about 8 hours/day, and hot-keep operation was carried out for the other times. Even after lapse of 5,000 hours, the output was more than 94% of the initial voltage, and it can be seen that the film electrode junction of the present invention was excellent in endurance even if hydrogen was used as the fuel.

### Example 24

Production of fuel cell:

FIG. 10 shows one example of fabrication of fuel cell 101 in which the film electrode junction produced in Example 1 was incorporated. The fuel cell 101 was fabricated by clamping a cathode terminal plate 103, a cathode current collector 104, a part 105 having the film electrode junction with diffusion layers produced in Example 1, a packing 106, an anode terminal plate 107, a fuel tank part 108, and an anode terminal plate 109 in succession by bolts and nuts.

(1) Production of fuel cell electric source system:

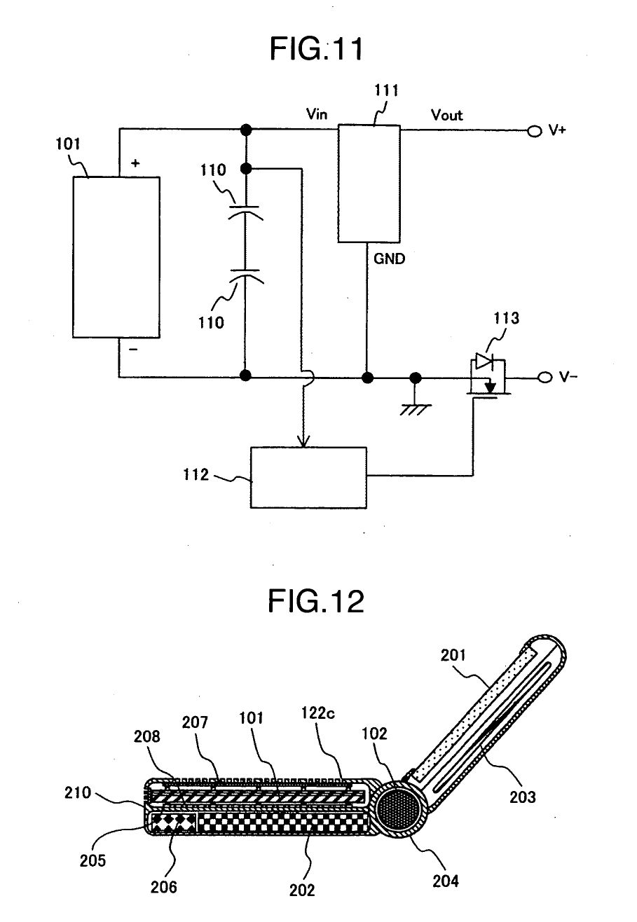

FIG. 11 shows one example of an electric source system in which the fuel cell 101 was incorporated. In FIG. 11, 101 indicates a fuel cell, 110 indicates an electric double layer condenser, 111 indicates a DC/DC converter, and 112 indicates a discriminative controlling means which controls ON and OFF of load cutting-off switch 113. In FIG. 11, the electric double layer condensers are in two series. The electricity generated from the fuel cell 101 is temporarily stored in the electric double layer condenser 110. The discriminative controlling means 112 measures the quantity of electricity in the electric double layer condenser, and when a given quantity of electricity is stored, the load cutting-off switch 113 is made ON to supply the electricity increased to a given voltage by the DC/DC converter to an electronic device.

(2) Production of portable information terminal:

FIG. 12 shows an example of a portable information terminal on which the fuel cell electric source system of the above (2) is mounted. This portable information terminal has a folding structure which comprises a part having therein a display device 201 integrally provided with a touch panel type input device and an antenna 203, and a part having therein a fuel cell 101, a main board 202 containing electronic devices and electronic circuits such as processor, volatile and non-volatile memories, power controlling part, fuel cell, secondary battery hybrid control and fuel monitor, and a lithium ion secondary battery 206, these two parts being connected by a hinge 204 having a cartridge holder which serves as a holder for fuel cartridge 102.

The part in which the electric source is provided is divided by a partition 205 of the case 210, and the main board 202 and the lithium secondary battery 206 are stored in the lower part and the fuel cell electric system is disposed in the upper part. Slits 122c for diffusing air and gas discharged from the cell are provided on the case and on the side wall portion, and an air filter 207 is provided on the surface of the slits 122c in the case 210 and a water absorption quick-drying material 208 is provided on the partition wall surface. The air filter is not particularly limited so long as it comprises a material which is high in diffusion of gas and inhibits entry of dusts or the like, and preferred are meshes or woven fabrics of single yarns of synthetic resins which do not cause clogging. In this Example, there are used meshes of polytetrafluoroethylene single yarns which are high in water repellency. This portable information terminal was operated stably for more than 2,000 hours.

### Example 25

An MEA was produced in the same manner as in Example 7, except that in the formation of polymer electrolyte film, a sulfomethylated polyether sulfone electrolyte was coated on the anode side of the polyolefin porous film 1, and 30% by weight of polyperfluorosulfonic acid electrolyte binder in a water/alcohol mixed solvent (a mixed solvent of water, isopropanol and n-propanol at a weight ratio of 20:40:40) was coated on the cathode side of the polyolefin porous film 1. The MEA having the diffusion layers was incorporated in the monocell of the polymer fuel cell electricity generation device, and cell performance was evaluated. As a fuel, an aqueous methanol solution of 20% by weight in concentration was circulated to the anode, and air was fed to the cathode. Continuous operation was carried out at 30° C. under application of a load of 50 mA/cm². The output voltages at a load of current density of 50 mA/cm² after 10 hours and 2,000 hours from the starting of the operation are shown in Table 6. The results of Example 7 are also shown in Table 6 for comparison.

When Example 25 and Example 7 in Table 6 are compared, it can be seen that the polymer electrolyte composite film in which a hydrocarbon electrolyte film was used for the anode and a fluorine-containing electrolyte film was used for the cathode as the polymer electrolyte film was superior in endurance to the polymer electrolyte composite film in which hydrocarbon electrolyte films were used for both the anode and cathode.

An SEM sectional photograph of the polymer electrolyte composite film 1 obtained in Example 25 is shown in FIG. 13. In the photograph, 301 indicates a polyolefin porous film layer filled with sulfomethylated polyether sulfone, 302 indicates an anode side electrolyte film layer (sulfomethylated polyether sulfone electrolyte film layer), and 303 indicates a cathode side electrolyte film layer (sulfomethylated polyether sulfone electrolyte film layer).

TABLE 6

| | | Example 7 | Example 25 | Example 26 | Example 27 |
|---|---|---|---|---|---|
| Anode | Diffusion | Hydrophilic | Hydrophilic | Hydrophilic | Hydrophilic |
| | layer | treatment | treatment | treatment | treatment |
| | | Carbon paper | Carbon paper | Carbon paper | Carbon paper |
| | Thickness of | 125 μm | 125 μm | 125 μm | 125 μm |
| | electrode | | | | |
| | Polymer | SM-PES*³ | SM-PES*³ | Nafion*⁴ | SM-PES*³ |
| | electrolyte | | | | |
| Polymer electrolyte film | | Composite | Composite | Composite | Composite |
| | | film*⁵ | film*⁵ | film*⁵ | film*⁵ |
| Cathode | Polymer | Nafion*⁴ | Nafion*⁴ | Nafion*⁴ | SM-PES*³ |
| | electrolyte | | | | |
| | Thickness of | 10 μm | 10 μm | 10 μm | 10 μm |
| | electrode | | | | |
| | Diffusion | Water repellent | Water repellent | Water repellent | Water repellent |
| | layer | treatment | treatment | treatment | treatment |
| | | Carbon cloth | Carbon cloth | Carbon cloth | Carbon cloth |

| | | | | |
|---|---|---|---|---|
| Output*¹ (mV at 50 mA/cm²) | 0.44 | 0.44 | 0.44 | 0.44 |
| Output*² (mv at 50 mA/cm²) | 0.36 | 0.44 | 0.43 | 0.41 |

*¹After 10 hours from starting of generation of electricity.
*²After 2,000 hours from starting of generation of electricity.
*³Sulfomethylated polyether sulfone.
*⁴Polyperfluorosulfonic acid.
*⁵A polymer electrolyte composite film in which a hydrocarbon electrolyte SM-PES*³ was used on the anode side and a fluorine-containing electrolyte Nafion was used on the cathode side.
*6: A polymer electrolyte composite film in which hydrocarbon electrolyte films were used for both the anode side and the cathode side.

### Example 26 and Example 27

The same experiment as of Example 25 was carried out using the fluorine-containing electrolyte Nafion as the polymer electrolyte of the cathode electrode or anode electrode, and the results are shown in the column of Example 26 in Table 6, and the same experiment as of Example 25 was carried out using the hydrocarbon electrolyte SM-PES as the polymer electrolyte of the cathode electrode or anode electrode, and the results are shown in the column of Example 27 in Table 6. Furthermore, an SEM sectional photograph of the polymer electrolyte composite film obtained in Example 27 is shown in FIG. 14. In the photograph, 304 indicates a polyolefin porous film layer filled with sulfomethylated polyether sulfone, 305 indicates an anode side electrolyte film layer (sulfomethylated polyether sulfone electrolyte film layer), and 306 indicates a cathode side electrolyte film layer (fluorine-containing electrolyte film layer).

When Example 26 and Comparative Example 1 are compared, it can be seen that when a fluorine-containing electrolyte was used as the polymer electrolyte of the cathode electrode and anode electrode, the polymer electrolyte composite film in which a hydrocarbon electrolyte film was used for the anode and a fluorine-containing electrolyte film was used for the cathode as the polymer electrolyte film was superior in endurance to the use of a hydrocarbon electrolyte as the polymer electrolyte.

When Example 27 and Comparative Example 2 are compared, it can be seen that when a hydrocarbon electrolyte was used as the polymer electrolyte of the cathode electrode and anode electrode, the polymer electrolyte composite film in which a hydrocarbon electrolyte film was used for the anode and a fluorine-containing electrolyte film was used for the cathode as the polymer electrolyte film was superior in endurance to the use of a hydrocarbon electrolyte film as the polymer electrolyte.

According to the Examples of the present invention, in the case of using a hydrocarbon electrolyte film as the polymer electrolyte film of the film electrode junction, adhesion between the hydrocarbon electrolyte film and the anode electrode became stronger by using a hydrocarbon electrolyte as a polymer electrolyte binder of the anode electrode, and deterioration of the polymer electrolyte binder in the cathode electrode hardly occurred by using a fluorine-containing electrolyte as a polymer electrolyte binder of the cathode electrode, and as a result, generation of electricity by the fuel cell could be performed stably for a long time.

Furthermore, a polymer electrolyte composite film in which a hydrocarbon electrolyte film was used on the anode side and a fluorine-containing electrolyte film was used on the cathode side as polymer electrolyte film of the film electrode junction was superior in endurance to a polymer electrolyte composite film in which a hydrocarbon electrolyte film was used on the anode side and a fluorine-containing electrolyte film was used on the cathode side as the hydrocarbon electrolyte film or the polymer electrolyte film.

By using the direct methanol fuel cell electric source system which uses the film electrode junctions of the Examples of the present invention as a battery charger provided in portable telephones, portable personal computers, portable audios, visual equipments and other portable information terminals which have secondary batteries mounted therein, or by directly using as a built-in electric source without using the secondary batteries, these electronic equipments can be used for a long time and can be continuously used by supplying fuels. Moreover, polymer fuel cells which use the film electrode junction of the present invention and use hydrogen as a fuel can be used for a long period of time and can be continuously used by supply of fuels as household and business cogeneration dispersion electric sources and fuel cell electric sources for mobiles.

It should be further understood by those skilled in the art that although the foregoing description has been made on embodiments of the invention, the invention is not limited thereto and various changes and modifications may be made without departing from the spirit of the invention and the scope of the appended claims.

Advantages of the Invention

According to the present invention, generation of electricity by fuel cells can be carried out stably for a long time without deterioration of the film electrode junction.

1. A film electrode junction comprising:
a polymer electrolyte film; and
a cathode electrode and an anode electrode between which the polymer electrolyte film is interposed;
wherein the cathode electrode and the anode electrode respectively contain a carbon powder, an electrode catalyst supported on the carbon powder and a polymer electrolyte binder;
at least one of the polymer electrolyte binder of the cathode electrode and a cathode side electrolyte film contain a fluorine-containing electrolyte; and
at least one of the polymer electrolyte binder of the anode electrode and an anode side electrolyte film contain a hydrocarbon electrolyte.

2. A film electrode junction comprising:
a polymer electrolyte film; and
a cathode electrode and an anode electrode between which the polymer electrolyte film is interposed;
wherein the cathode electrode and the anode electrode contain at least a carbon powder, an electrode catalyst supported on the carbon powder and a polymer electrolyte binder;
the polymer electrolyte binder of the cathode electrode is a fluorine-containing electrolyte; and
the polymer electrolyte binder of the anode electrode is a hydrocarbon electrolyte.

3. A film electrode junction comprising:
a polymer electrolyte film; and
a cathode electrode and an anode electrode between which the polymer electrolyte film is interposed;
wherein the cathode electrode and the anode electrode contain at least a carbon powder, an electrode catalyst supported on the carbon powder and a polymer electrolyte binder;
a cathode electrode side of the polymer electrolyte film is a fluorine-containing electrolyte; and
the polymer electrolyte binder of the anode electrode is a hydrocarbon electrolyte.

4. A film electrode junction according to claim 1, wherein the polymer electrolyte film is a hydrocarbon electrolyte film.

5. A film electrode junction according to claim 1, wherein an anode side of the polymer electrolyte film is a hydrocarbon electrolyte film and a cathode side of the polymer electrolyte film is a fluorine-containing electrolyte film.

6. A film electrode junction according to claim 1, wherein the hydrocarbon electrolyte is a hydrocarbon electrolyte into which an alkylenesulfonic acid group is introduced.

7. A film electrode junction according to claim 1, wherein the polymer electrolyte film is an engineering plastics into which a sulfonic acid group is introduced.

8. A film electrode junction according to claim 1, wherein thefluorine-containing electrolyte is polyperfluorosulfonic acid.

9. A fuel cell in which the film electrode junction according to claim 1 is incorporated.

10. A fuel cell electric source system in which the fuel cell electric source according to claim 9 is incorporated.

11. An electronic equipment in which the fuel cell electric source system according to claim 10 is incorporated.
